(19) United States
(12) Patent Application Publication
(10) Pub. No.: US 2005/0196740 A1
(43) Pub. Date: Sep. 8, 2005

(54) Simulator system and training method for endoscopic manipulation using simulator

(75) Inventor: Hiroki Moriyama, Tokyo (JP)

Correspondence Address: OSTROLENK FABER GERB & SOFFEN, 1180 AVENUE OF THE AMERICAS, NEW YORK, NY, 100368403, US

(73) Assignee: Olympus Corporation

(21) Appl. No.: 10/959,850

(22) Filed: Oct. 6, 2004

Related U.S. Application Data
(60) Provisional application No. 60/551,106, filed on Mar. 8, 2004.

(51) Int. Cl. G09B 23/28

(52) U.S. Cl. 434/262

(57) ABSTRACT

An endoscopic simulator system includes an endoscope, a detector, a three-dimensional image measuring device, and an image processor. The endoscope is usable for endoscopic simulation. The endoscope has an elongated insertion section and a control section for manipulating the insertion section. The detector detects a movement of the insertion section to obtain activity data on the insertion section. The image measuring device three-dimensionally measures the interior of a patient's body to obtain internal organ shape data. The image processor constructs a virtual three-dimensional image of the interior of the patient's body supposed to be observed through the endoscope, based on the organ shape data obtained from the image measuring device and the activity data on the insertion section obtained from the detector.

### CROSS-REFERENCE TO RELATED APPLICATIONS

This application claims the benefit of U.S. Provisional Application No. 60/551,106, filed Mar. 8, 2004.

### BACKGROUND OF THE INVENTION

1. Field of the Invention

This invention relates to an endoscopic simulator system and a training method for endoscopic manipulation using an endoscopic simulator.

2. Description of the Related Art An endoscopic simulator system is described in “Development of Colonoscopy Teaching Simulation,” Endoscopy, 2000, 32(II), pp. 901-905, by C. B. Williams et al. This system can perform endoscopic procedure training through virtual inspection using a computer. In this endoscopic simulator system, a storage unit in the computer is previously stored with a plurality of virtual models for various target organs. Thus, an operator estimates models, such as organ shapes, from a patient's figure and selects the stored virtual models as he/she undergoes the training.

A novel imaging means is described in “Prospects of Virtual Endoscopy,” Digestive Endoscopes, Vol. 12, No. 7, 2000, pp. 1,025-1,029, by Kuwayama, Nozaki, et al. This means uses a computer to reconstruct information that is obtained by means of a CT or MR scanner, thereby forming an intracanal image that resembles an image actually obtained with an endoscope.

### BRIEF SUMMARY OF THE INVENTION

According to one aspect of the present invention, there is provided an endoscopic simulator system, including: an endoscope having an elongated insertion section and a control section for manipulating the insertion section, the endoscope being usable for endoscopic simulation;

a detector which detects a movement of the insertion section to obtain activity data on the insertion section;

a three-dimensional image measuring device which three-dimensionally measures the interior of a patient's body to obtain internal organ shape data; and

an image processor which constructs a virtual three-dimensional image of the interior of the patient's body supposed to be observed through the endoscope, based on the organ shape data obtained from the three-dimensional image measuring device and the activity data on the insertion section obtained from the detector.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a schematic view showing a general configuration of an endoscopic simulator system according to a first embodiment;

FIG. 2 is a schematic perspective view showing an external appearance of a box-shaped endoscope manipulation detection controller of the endoscopic simulator system shown in FIG. 1 according to the first embodiment;

FIG. 3 is a schematic view showing an extractive outside image of a large intestine obtained when the intestine and its surroundings are measured with use of a CT scanner shown in FIG. 1 according to the first embodiment;

FIG. 4 is a schematic view showing a part of the large intestine transformed when a desired position (bent part) on the simulator unit shown in FIG. 2 is subjected to manual compression according to the first embodiment; and

FIG. 5 is a schematic view showing the way manual compression is simulated with a pointer in a desired position on an external image according to a second embodiment.

### DETAILED DESCRIPTION OF THE INVENTION

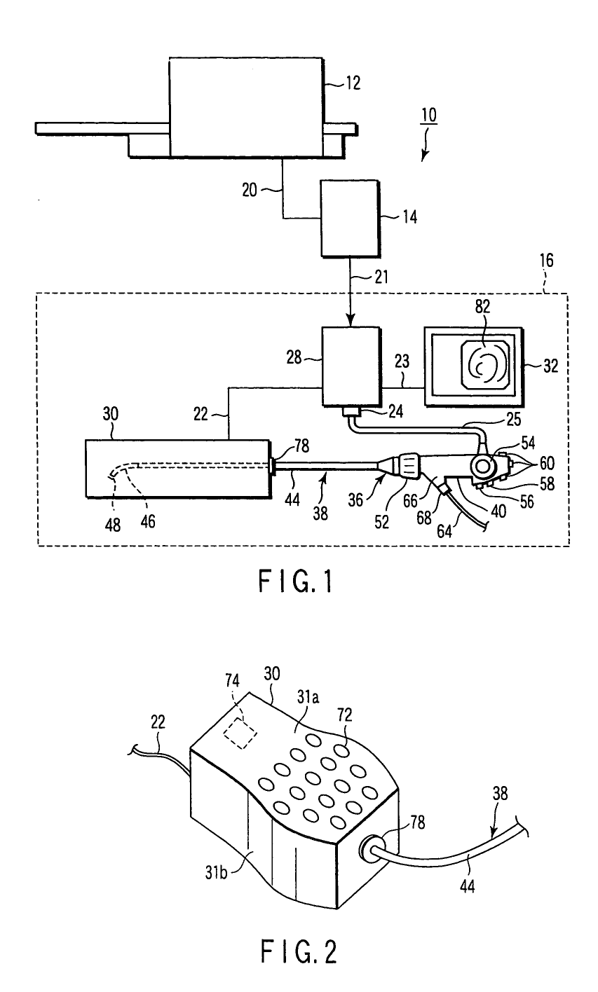

Preferred embodiments of this invention will now be described with reference to the accompanying drawings. FIGS. 1 to 4 show a first embodiment of the invention.

As shown in FIG. 1, an endoscopic simulator system 10 includes a high-speed helical CT scanner (three-dimensional image measuring device) 12, data storage unit 14, and main system 16.

The CT scanner 12 can scan a target human organ and its peripheral regions. A signal conductor 20 electrically connects the scanner 12 and the data storage unit 14, which stores data that are scanned by the scanner 12. The main system 16 is connected electrically to the data storage unit 14 by means of a data transmission cord 21.

The main system 16 includes a simulation data processor 28, endoscope manipulation detector (dummy likened to a patient's body) 30, monitor (display unit) 32, and dummy endoscope 36. The simulation data processor 28 is connected electrically to the data storage unit 14 by the data transmission cord 21. The detector 30 is connected electrically to the processor 28 by a signal conductor 22. The monitor 32 is connected electrically to the processor 28 by a signal conductor 23. The dummy endoscope 36 is connected electrically to the processor 28 by a connector 24 thereon and a cord 25 that is connected to the connector 24.

The dummy endoscope 36 is provided with an elongated insertion section 38 and a control section 40 attached to the proximal end portion of the insertion section 38.

The insertion section 38 has a flexible portion 44 that is coupled to the control section 40. A bending portion 46 is attached to the distal end of the flexible portion 44. It is bent by manipulating a bending knob 54, which will be mentioned later. A tip portion 48 that regulates the direction of observation is attached to the distal end of the bending portion 46. The tip portion 48, bending portion 46, and flexible portion 44 are releasably introduced into the endoscope manipulation detector 30. The tip portion 48 and the bending portion 46 may be provided only virtually, not actually.

A hardness adjusting knob 52 for regulating the hardness of the flexible portion 44 of the insertion section 38 is located on an easily accessible region of the control section 40, e.g., its distal end portion. A bending control knob 54 for bending the bending portion 46 is provided on the proximal end side of the control section 40. If the bending portion 46 is virtual, the bending degree on the distal end side of the insertion section 38 is set virtually.

Arranged on the proximal end side of the bending control knob 54 are an air/water feed button 56, a suction button 58, and image control switches 60. The feed button 56 serves for air and/or water fed through the tip portion 48 of insertion section 38. The suction button 58 is used to start external suction into the tip portion 48 of the insertion section 38. The control switches 60 are used to control an image that is observed through an observation optical system.

A tool inlet port 66 through which an endo-therapy product 64 is introduced into the insertion section 38 protrudes from a specific region of the control section 40, e.g., a region between the hardness adjusting knob 52 and the bending control knob 54. The tool inlet port 66 is provided with a tool movement detecting element 68 for detecting the movement of the product 64.

The tool movement detecting element 68 has a calibration (normalization) function. This function can locate a starting point for the insertion of the endo-therapy product 64 into the tool movement detecting element 68 so that it corresponds to a given position in the patient's body (virtual organ). With use of this calibration function, the position of, e.g., the distal end of the product 64 on a simulation image can be regulated.

The control section 40 of the dummy endoscope 36 constructed in this manner is connected electrically to the simulation data processor 28 by means of the cord 25 and the connector 24.

The processor 28 has an image processing function to read and image organ shape data that are stored in the data storage unit 14. The processor 28 further has a calculation function to combine the organ shape data with detection data on the movement of the insertion section 38 of the dummy endoscope 36, which are obtained by operating the control section 40, thereby constructing a virtual image that is supposed to be observed through the tip portion 48 of the insertion section 38.

The processor 28 further has an image reprocessing function. According to this function, the organ shape data and the detection data on the movement of the insertion section 38 are calculated one by one as an external force on the virtual organ and its surroundings varies. The calculated data are reprocessed to reconstruct the image in detail. The processor 28 has a transmission function to transmit the image constructed by the image processing and reprocessing functions to the monitor 32 through the signal conductor 23 so that the image is displayed on a display screen.

As shown in FIG. 2, the endoscope manipulation detector 30 has the shape of a hollow box, for example. One face (top face as in FIG. 2) of the detector 30 is regarded as a front 31a. A large number of pressure detecting elements (pressure sensors) 72 are juxtaposed in a matrix on the front 31a. They are used to detect the distribution of pressure that is applied to the front 31a by an operator. Further arranged on the front 31a is a gravitational direction detecting element (gravitational direction sensor) 74, which detects the direction of gravity that acts on the detector 30. Thus, the detector 30 is provided with an external force measuring device that measures an external force on the detector 30. Alternatively, the detector 30 may be in a human shape, for example.

An inlet portion of the detector 30 through which the insertion section 38 of the dummy endoscope 36 is introduced into the detector 30 is provided with an insertion section movement controller 78. The controller 78 detects the movement of the insertion section 38 relative to the detector 30 and feeds back a force (mentioned later) to the insertion section 38. The controller 78 may alternatively be located inside the detector 30.

Sensors (not shown), such as a pressure sensor, and photo sensor, are arranged in the detector 30. They detect the movement of the insertion section 38 of the dummy endoscope 36 with respect to the detector 30. The detector 30 has a calibration (normalization) function. This function can locate a starting point for the insertion of the insertion section 38 into the detector 30 so that it corresponds to a desired position in the patient's body (virtual organ). With use of this calibration function, the position of, e.g., the tip portion 48 of the insertion section 38 on a simulation image can be regulated.

There are various types of dummy endoscopes 36 that are different in specifications, such as the outer diameter and hardness of the insertion section 38. For example, there is a lineup of dummy endoscopes 36 that share the specifications with endoscopic products used in actual endoscopic procedures. Preferably, the same endoscope as is actually employed in surgical operations should be used as the dummy endoscope 36. For example, product lineups with different specifications, including the outer diameter and hardness of the insertion section 38, can be set on the simulation data processor 28 (computer). If the insertion section 38 is actually provided with the tip portion 48 and the bending portion 46, it may be used in combination with the endo-therapy product 64 for surgical operation.

The following is a description of the function of the endoscopic simulator system 10.

The CT scanner 12 shown in FIG. 1 is used to scan the region around the patient's target organ (large intestine in this case). Scan data on the large intestine that is scanned by the CT scanner 12 are transmitted through the signal conductor 20 to the data storage unit 14 and stored in it.

The scan data stored in the data storage unit 14 are transmitted through the data transmission cord 21 to the simulation data processor 28. The storage unit 14 may be separated from the main system 16. In other words, the electrical connection between the storage unit 14 and the main system 16 by means of the cord 21 may be canceled.

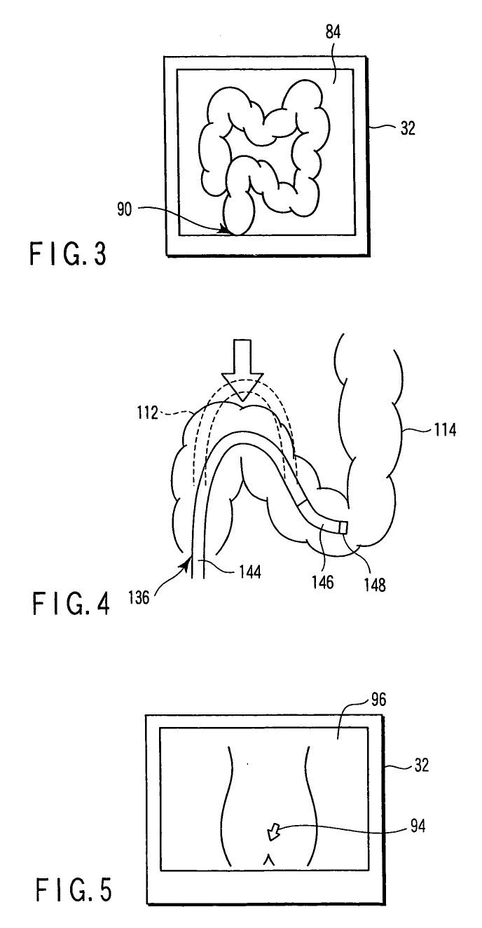

Based on the scan data transmitted from the data storage unit 14, the processor 28 uses its image processing function to construct three-dimensional shape data (three-dimensional image data) on the large intestine. There are pluralities of types of three-dimensional images of the intestine that are based on the three-dimensional shape data. They include an intracanal image 82 of the intestine displayed on the display screen of the monitor 32 in FIG. 1, an extractive outside image 84 of the entire intestine on the screen of the monitor 32 in FIG. 3, and an image (not shown) of the intestine and its surroundings, etc. These images may be changed into a single image by means of a switch (not shown). Alternatively, a plurality of images may be displayed on the single monitor 32. If a relatively large lesion, such as a polyp, exists in the large intestine, therefore, the operator can easily recognize its position and size by the three-dimensional images.

The calibration function of the detector 30 is used in advance to set (calibrate) a starting point 90 for the insertion of the insertion section 38 of the dummy endoscope 36 into the detector 30.

If the operator manipulates the control section 40 of the dummy endoscope 36 set in the endoscope manipulation detector 30, manipulated variable data based on the manipulation is transmitted to the processor 28 through the cord 25 and the connector 24. If the bending control knob 54, air/water feed button 56, suction button 58, control switches 60, etc., of the control section 40 are manipulated as required, the movements of their manipulation are transmitted to the processor 28 through the cord 25 and the connector 24. Thereupon, the manipulation is performed virtually. If the bending control knob 54 is manipulated, for example, the bending portion 46, like that of an actual endoscope, bends, whereupon the bending degree of the tip portion 48 of the insertion section 38 is regulated virtually.

If the insertion section 38 of the dummy endoscope 36 is moved relatively to the insertion section movement controller 78 on the endoscope manipulation detector 30, the movement is detected by the controller 78. Detection data from the controller 78 is transmitted to the processor 28 through the signal conductor 22.

Twisting or bending movement of the tip portion 48 of the insertion section 38 can be detected by the pressure sensor or photosensor (not shown) in the detector 30. Detection data from the detector 30 is transmitted to the processor 28 through the signal conductor 22. Thus, the manipulated variable data on the manipulation of the control section 40 and the detection data detected by the detector 30 are compared by the processor 28, and calibration quantity of the detection data is set for each manipulation movement.

The processor 28 constructs an endoscopic simulation image in the detector 30 (dummy likened to the patient's body) by combining the three-dimensional image data on the large intestine and detection data on the movement of the insertion section 38 based on the manipulation of the control section 40.

In carrying out simulation using a combination of the dummy endoscope 36 and the endo-therapy product 64, without being limited to the single use of the dummy, the product 64 is inserted into the insertion section 38 of the endoscope 36 through the tool movement detecting element 68 of the control section 40. The endo-therapy product 64 is subjected to the same operation as the operation for setting the starting point 90 for the insertion of the insertion section 38 of the dummy endoscope 36. Thus, the calibration function of the detecting element 68 is used in advance to set (calibrate) a starting point (not shown) for the insertion of the product 64 into the detecting element 68.

When the operator manipulates the control section 40 of the dummy endoscope 36, the manipulated variable data on the control section 40 is transmitted to the processor 28 through the cord 25 and the connector 24. The detection data on the insertion section 38 that is based on this manipulation is transmitted to the processor 28 through the signal conductor 22.

Based on the three-dimensional image data and the detection data, the processor 28 uses its image processing and reprocessing functions to construct a three-dimensional image of the interior of the large intestine that is supposed to be observed through the tip portion 48 of the insertion section 38. Using the transmission function, the processor 28 transmits the constructed image to the monitor 32 through the signal conductor 23, whereupon the image is displayed on the display screen of the monitor 32.

If the control section 40 is manipulated to move the tip portion 48 of the insertion section 38, images are repeatedly constructed by the simulation image reprocessing function of the processor 28. Thereupon, an image can be obtained by simulating an image from an optical system in an actual endoscope. A superimposed image of the large intestine and the insertion section 38 may be constructed and displayed on the display screen of the monitor 32. Thus, the extent of insertion (not shown) of the insertion section 38 of the dummy endoscope 36 in the external image 84 of the intestine can be also displayed.

If a part of the insertion section 38 of the dummy endoscope 36 is in contact with the inner wall of the large intestine on the display screen of the monitor 32, the manipulation of the dummy endoscope can be made difficult. If the tip portion 48 of the insertion section 38 is held against the inner wall of the intestine, for example, the processor 28 actuates the insertion section movement controller 78 to prevent the insertion section 38 from moving forward. If the insertion section 38 moves so as to protrude from a specified region of the three-dimensional image of the large intestine, for example, a force of the controller 78 to prevent the movement of the insertion section 38 is fed back to the control section 40 and the like. Thus, manipulation of the bending control knob 54 is prevented, for example. The controller 78 may be designed for control such that it can prevent the movement of the bending portion 46.

According to the aforementioned endoscopic simulator system by C. B. Williams et al., an endoscopic procedure can be simulated for an organ of a shape selected among a plurality of types. Since the organ to be simulated is not a patient's actual organ that is undergoing an endoscopic operation, for example, however, it is impossible to reproduce an accurate endoscopic treatment that matches the patient's specificity. Thus, the endoscopic simulator system by C. B. Williams et al. is nothing but a training system.

On the other hand, the following holds for the endoscopic simulator system 10 according to this embodiment.

In the endoscopic simulator system 10, an internal endoscopic simulation image can be formed by combining organ shape data on an actual patient's organ (e.g., large intestine), which is obtained by means of, for example, the high-speed helical CT scanner 12 and detection data on the movement (manipulated variable) of the insertion section 38 of the dummy endoscope 36. Since the simulation image can be constructed in this manner, the operator can conduct image recognition training, and besides virtually perform treatment for an actual organ shape.

The dummy endoscope 36 is available having the insertion section 38 that has optimum outer diameter and hardness for the endoscopic procedure. Thus, a treatment for an organ of the same shape as an actual patient's organ and a lesion in the organ can be simulated by means of the same endoscope for the procedure before a surgical operation for the actual patient is performed.

With use of the endoscopic simulator system 10, therefore, the optimum endoscope for the actual procedure can be selected, and the speedy, accurate endoscopic procedure based on simulation can be carried out in accordance with the patient's specificity.

When using the endoscopic simulator system 10, the specifications of the dummy endoscope 36 are selected by means of the computer (processor 28). The dummy endoscope 36 can be virtually produced so that it is designed more appropriately than an actual endoscope product lineup. This helps the development of novel endoscope products.

Postural reposition or manual compression is a procedure that facilitates the insertion section of a conventional (or actual) flexible endoscope to be inserted into, e.g., the large intestine of a patient.

The postural reposition is a way of changing the direction in which the gravity acts on a bent part of the large intestine. In other words, it is reorientation of the patient's body. Deflection of the bent part of the intestine can be increased or reduced by changing the direction of movement of the patient's gravity. The insertion of the insertion section of the endoscope into the intestine can be facilitated by subjecting the patient to postural reposition if the insertion section is caught by, for example, the bent part of the intestine and cannot be easily inserted deeper.

As shown in FIG. 4, on the other hand, the manual compression is a way of pressing an external part of the patient's body, thereby transforming the bent part of the large intestine to reduce its deflection. The insertion of the insertion section of the endoscope into the intestine can be facilitated by subjecting the patient to manual compression if the insertion section is caught by, for example, the bent part of the intestine and cannot be easily inserted deeper.

Thus, the postural reposition or manual compression is one of the important procedures to insert the insertion section of the endoscope into the large intestine, for example. The control section or insertion section of the endoscope can be also pushed, pulled, twisted, and bent with use of a conventional endoscopic simulator system. However, an essential procedure, such as postural reposition or manual compression, cannot be tried with the conventional system. Therefore, the conventional system is not a satisfactory endoscopic simulator system with which the patient is subjected to procedure training.

A simulator unit 30 described here may be used as the endoscope manipulation detector 30 of the endoscopic simulator system 10 shown in FIG. 1 or used singly.

The following is a description of the function of the simulator unit (endoscope manipulation detector) 30 that can simulate important procedures, such as postural reposition, manual compression, etc., and help the progress of endoscopic procedures.

A case where the simulator unit 30, a patient dummy, of the endoscopic simulator system 10 is subjected to postural reposition will be described first.

The operator (trainee) tilts the front 31a of the top surface of the box-shaped simulator unit 30 shown in FIG. 2, thereby moving it to the position of a flank portion 31b. Thus, the gravitational direction detecting element 74 is moved from the front 31a to the flank portion 31b of FIG. 2.

Gravitational direction data are detected by the gravitational direction detecting element 74 every time their variation exceeds a given threshold value or at appropriate time intervals. The following description is based on the case where the data are detected at appropriate intervals.

The gravitational direction data are transmitted one by one from the gravitational direction detecting element 74 to the simulation data processor 28 shown in FIG. 1 through the signal line 22. The processor 28 uses its image reprocessing function successively to recalculate changes of the direction of the gravity that acts on the large intestine for each of the gravitational direction data that are transmitted at appropriate time intervals. The organ shape data in the processor 28 are converted to form new images of the intestine in succession. More specifically, if the operator subjects the simulator unit 30 to postural reposition so that the direction of the gravity applied to the detecting element 74 is changed, the simulation image of the intestine is transformed on a real-time basis in accordance with the change of the gravitational direction. As this is done, the processor 28 uses its image reprocessing function to calculate the transformation of the surroundings of the intestine, as well as its transformation in the gravitational direction. Thus, it constructs an image of the surroundings of the intestine together with that of the intestine itself.

If the operator thus subjects the simulator unit 30 to postural reposition in various directions, he/she can observe responses of the simulation image of the large intestine to the gravitational direction one by one through the monitor 32.

The following is a description of a case where the insertion section 38 of the dummy endoscope 36 is located in the simulator unit 30 when the simulator unit is subjected to postural reposition.

In this case, the processor 28 uses its image reprocessing function to calculate and image the state in which the insertion section 38 of the dummy endoscope 36 is located in the simulator unit 30. In other words, the image reprocessing function of the processor 28 is used to construct images of the large intestine shape and the bending degree of the insertion section 38. Shape data that combines the images of the large intestine and the insertion section 38 is displayed on the display screen. When this is done, the insertion section movement controller 78 is also actuated. Thus, the ability to move the insertion section 38 is regulated.

If the insertion section 38 of the dummy endoscope 36 is caught by the bent part of the large intestine and cannot be easily inserted, the operator subjects the simulator unit 30 to postural reposition while observing the simulation image through the display screen of the monitor 32. The direction of the postural reposition is a direction in which the large intestine is transformed so that the deflection of the bent part of the intestine that catches the insertion section 38 is reduced. Thereupon, the insertion section 38 of the dummy endoscope 36 can be inserted with ease. Thus, the procedures of the dummy endoscope 36 can be progressed by virtual training.

The front 31a of the simulator unit 30 is tilted at various angles from its upturned state as the unit 30 is subjected to the postural reposition. If this is done, responses of the virtual large intestine to the tilting movement are calculated by the simulation data processor 28 and observed one by one through the display screen of the monitor 32.

The following is a description of a case where the simulator unit 30 is subjected to manual compression.

FIG. 4 shows a sigmoid image 112, descending colon image 114, insertion section image 136, flexible portion image 144 of the insertion section 38, bending portion image 146, and tip portion image 148 with the insertion section 38 of the dummy endoscope 36 in the large intestine and subjected to the manual compression. If that part of the intestine which corresponds to the sigmoid image 112 is subjected to the manual compression, as indicated by the arrow in FIG. 4, it is transformed in a direction such that the deflection of the sigmoid image 112 is reduced. Thus, the insertion section 38 of the dummy endoscope 36 can be inserted easily into the large intestine.

The operator (trainee) presses some of the pressure detecting elements 72 that are arranged in a matrix on the front 31a of the simulator unit 30 shown in FIG. 2. The depressed detecting elements 72 individually detect forces of pressure from the operator. Pressure data are obtained by the detecting elements 72 every time their variation exceeds a given threshold value or at appropriate time intervals. The following description is based on the case where the data are detected at appropriate intervals.

The pressure data are transmitted one by one from the pressure detecting elements 72 to the simulation data processor 28 shown in FIG. 1 through the signal line 22. The processor 28 uses its image reprocessing function successively to recalculate changes of the distribution of pressures that act on the large intestine for each of the pressure data that are transmitted at appropriate time intervals. Thus, the organ shape data in the processor 28 are changed to form new images of the intestine in succession. More specifically, if the operator subjects the simulator unit 30 to manual compression so that the distribution of the pressures applied to the detecting elements 72 is changed, the simulation image of the intestine is transformed on a real-time basis in accordance with the pressure change. As this is done, the processor 28 uses its image reprocessing function to calculate the transformation of the surroundings of the large intestine, as well as its transformation in the gravitational direction. Thus, it constructs an image of the surroundings of the intestine together with that of the intestine itself.

If the operator thus subjects the simulator unit 30 to manual compression in various directions, he/she can observe responses of the simulation image of the large intestine to the pressure distribution one by one through the monitor 32.

The following is a description of a case where the insertion section 38 of the dummy endoscope 36 is located in the simulator unit 30 when the simulator unit is subjected to manual compression.

In this case, the processor 28 uses its image reprocessing function to calculate and image the state in which the insertion section 38 of the dummy endoscope 36 is located in the simulator unit 30. In other words, the image reprocessing function of the processor 28 is used to construct images that indicate the large intestine shape and the bending degree of the insertion section 38. Shape data that combines the images of the large intestine and the insertion section 38 is displayed on the display screen of the monitor 32. When this is done, the insertion section movement controller 78 is also actuated. Thus, the ability to move the insertion section 38 is regulated.

If the insertion section 38 of the dummy endoscope 36 is caught by the bent part of the large intestine and cannot be easily inserted, the operator subjects the simulator unit 30 to manual compression while observing the simulation image through the display screen of the monitor 32. The large intestine is transformed in a direction such that the deflection of its bent part is reduced. Thereupon, the insertion section 38 of the dummy endoscope 36 can be inserted with ease. Thus, the procedures of the dummy endoscope 36 can be progressed by virtual training.

If various parts of the front 31a are subjected to the manual compression, responses of the virtual large intestine to depressed regions are calculated by the simulation data processor 28 and observed one by one through the display screen of the monitor 32.

The procedures including the postural reposition, manual compression, etc., may be performed singly or in combination with one another as required.

As described above, the postural reposition, manual compression, and other procedures can be performed virtually. Since the virtual large intestine is transformed on a real-time basis in response to these procedures, the movement of the large intestine can be easily imaged when an actual patient is subjected to a procedure such as the postural reposition or manual compression. Thus, the insertion section of an endoscope can be easily actually inserted into the intestine.

Thus, the following holds for the first embodiment.

Endoscopic procedure simulation that copes with patients' individual differences can be carried out with use of the endoscopic simulator system 10. Thus, the simulator unit of this embodiment serves better for the progress of endoscopic procedures than conventional simulator units.

An actual endoscopic procedure can be performed by making the most of experience on the use of the endoscopic simulator system 10.

Although the large intestine has been described as a typical organ in connection with this embodiment, a stomach, for example, may be also subjected to procedure training using the endoscopic simulator system 10.

A second embodiment will now be described with reference to FIG. 5. This embodiment is a modification of the first embodiment. Therefore, like numerals are used to designate like members of the two embodiments, and a detailed description of those members is omitted.

The following is a description of a case where a procedure, such as postural reposition or manual compression, is virtually performed on a computer, such as the processor 28, instead of using the box-shaped endoscope manipulation detector 30.

A computer mouse (manipulating force input mechanism) is connected to the processor 28 and used to control it. As shown in FIG. 5, a pointer 94 of the mouse is displayed on the monitor 32. A virtual image of a patient is shown in FIG. 5.

There will first be described the way a postural reposition procedure is performed on the computer.

The virtual image of the patient can be rotated around its longitudinal axis by clicking the mouse button. The rotation is regulated by the movement of the mouse, for example. If the mouse button is kept depressed as the mouse is moved virtually to perform the postural reposition procedure, for example, therefore, the patient's virtual image on the monitor 32 rotates.

As this is done, the processor 28 calculates the deflection of the bent part of the large intestine. If the mouse button is released, the entire large intestine image on the display screen of the monitor 32 shown in FIG. 3 is extracted and changed into the external image 84. Thereupon, a behavior of the bent part of the intestine that is caused by the virtual postural reposition is imaged.

The following is a description of the way a manual compression procedure is performed on the computer.

The mouse button is clicked with its pointer 94 located in a desired position on an external image 96 of the patient who is virtually laid down in a desired posture, as shown in FIG. 5. Thereupon, the position of the pointer 94 is virtually subjected to manual compression. Change of the large intestine shape that is caused by this operation is calculated by the processor 28, imaged on a real-time basis, and displayed on the display screen of the monitor 32. Thus, the operator can easily recognize the influence of the manual compression. If the manual compression is virtually performed in various positions, responses of the intestine shape change or the like to the positions of depression can be observed one by one through the monitor 32.

Preferably, the control section 40 of the dummy endoscope 36 should be provided with manipulation input means such as a joystick (not shown) that has the same function as the mouse pointer 94 shown in FIG. 5. The joystick can be used in place of the mouse to perform the postural reposition, manual compression, or other procedure in like manner.

Thus, the following holds for the second embodiment.

The manual compression and postural reposition, important endoscopic procedures, can be simulated by virtual displaying a patient's body on the monitor 32 with use of the processor 28 (computer). Influences of changes of the large intestine shape and the like that are attributable to the manual compression and manual compression can be understood visually. Use of the simulator unit 30 can serve for the progress of endoscopic procedures.

Thus, the following holds for the first and second embodiments.

The manual compression, postural reposition, and other procedures can be performed in the manner shown in FIG. 2 on the hardware side and in the manner shown in FIG. 5 on the software side, for example. In consequence, responses similar to those obtained with actual endoscopic procedures can be enjoyed when the same manipulation for the actual procedures is carried out on a simulation basis.

Accordingly, the operator can estimate influences of a given manipulation in treating an actual patient. In performing manipulation for the actual patient, therefore, the operator can perform procedures taking advantage of experience on the use of the simulator unit 30. Thus, there may be provided the endoscopic simulator unit 30 that can simulate the postural reposition, manual compression, and other essential procedures so that the operator can visually understand the procedures, thereby serving for the progress of endoscopic procedures.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An endoscopic simulator system, comprising:
an endoscope having an elongated insertion section and a control section for manipulating the insertion section, the endoscope being usable for endoscopic simulation;
a detector which detects a movement of the insertion section to obtain activity data on the insertion section;
a three-dimensional image measuring device which three-dimensionally measures the interior of a patient's body to obtain internal organ shape data; and
an image processor which constructs a virtual three-dimensional image of the interior of the patient's body supposed to be observed through the endoscope, based on the organ shape data obtained from the three-dimensional image measuring device and the activity data on the insertion section obtained from the detector.

2. An endoscopic simulator system according to claim 1, wherein the detector includes control means which prevents the movement of the insertion section when the insertion section moves so as to touch a wall portion in the patient's body on the three-dimensional image.

3. An endoscopic simulator system according to claim 1, further including a display unit which displays the image formed by the image processor.

4. An endoscopic simulator system according to claim 1, wherein the three-dimensional image measuring device includes a computerized tomography scanner.

5. An endoscopic simulator system according to claim 4, wherein the three-dimensional image measuring device further includes a storage unit which stores data scanned by the computerized tomography scanner.

6. An endoscopic simulator system according to claim 1, wherein the three-dimensional image measuring device includes a data processor which changes the organ shape data in accordance with an external force supposed to be applied to the patient's body.

7. An endoscopic simulator system according to claim 1, wherein the detector includes a dummy likened to the patient's body and having therein the insertion section for the movement, the dummy including an insertion section detecting mechanism which detects the movement of the insertion section and an external force measuring mechanism which measures an external force applied to the dummy.

8. An endoscopic simulator system according to claim 7, wherein the external force measuring mechanism includes a gravitational direction sensor which measures the gravity of the dummy and the direction of the gravity.

9. An endoscopic simulator system according to claim 8, wherein the external force measuring mechanism includes a press force direction sensor which measures a press force with which the dummy is pressed and the direction of the press force.

10. An endoscopic simulator system according to claim 7, wherein the external force measuring mechanism includes a press force direction sensor which measures a press force with which the dummy is pressed and the direction of the press force.

11. An endoscopic simulator system according to claim 7, wherein the dummy can be provided with insertion sections of a plurality of types of endoscopes having different specifications.

12. An endoscopic simulator system according to claim 7, wherein the insertion section of the endoscope has a virtual tip portion which is operated by manipulating the control section.

13. An endoscopic simulator system, comprising:
an endoscope having an elongated insertion section and a control section for manipulating the insertion section, the endoscope being usable for endoscopic simulation;
detecting means which detects a movement of the insertion section to obtain activity data on the insertion section;
three-dimensional image measuring unit which three-dimensionally measures the interior of a patient's body to obtain internal organ shape data; and
image processing means which constructs a virtual three-dimensional image of the interior of the patient's body supposed to be observed through the endoscope, based on the organ shape data obtained from the three-dimensional image measuring unit and the activity data on the insertion section obtained from the detecting means.

14. An endoscopic simulator system according to claim 13, wherein the detecting means includes control means which prevents the movement of the insertion section when the insertion section moves so as to touch a wall portion in the patient's body on the three-dimensional image.

15. An endoscopic simulator system according to claim 13, further including a display unit which displays the image formed by the image processor.

16. An endoscopic simulator system according to claim 13, wherein the three-dimensional image measuring unit includes a data processor which changes the organ shape data in accordance with an external force supposed to be applied to the patient's body.

17. An endoscopic simulator system according to claim 16, wherein the data processor includes first image reprocessing means which computes the organ shape data based on change of the gravitational direction of the patient's body when the gravitational direction is virtually changed, and second image reprocessing means which computes the organ shape data based on a press force and the direction of the press force when the press force is virtually applied to the patient's body.

18. An endoscopic simulator system according to claim 13, wherein the detecting means includes a dummy likened to the patient's body and having therein the insertion section for a movement, the dummy including an insertion section sensor which detects the movement of the insertion section and an external force sensor which measures an external force applied to the dummy.

19. An endoscopic simulator system according to claim 13, wherein the insertion section of the endoscope has a virtual tip portion which is operated by manipulating the control section.

20. A training method for endoscopic manipulation using an endoscopic simulator, comprising:
three-dimensionally measuring the interior of a patient's body to obtain three-dimensional data on a target region in the body;
forming a three-dimensional image of the interior of the patient's body based on the three-dimensional data;
normalizing an insertion section of an endoscope, located in a dummy likened to the patient's body, with respect to the three-dimensional image;
manipulating and actuating the insertion section with respect to the dummy; and
changing the three-dimensional image in detail in accordance with the movement of the insertion section.

21. A training method for endoscopic manipulation using an endoscopic simulator, comprising:
three-dimensionally measuring the interior of a patient's body to obtain three-dimensional data on a target region in the body;
forming a three-dimensional image of the interior of the patient's body based on the three-dimensional data;
normalizing an insertion section of an endoscope, located in a dummy likened to the patient's body, with respect to the three-dimensional image;
manipulating and actuating the insertion section with respect to the dummy; and
changing the three-dimensional image in detail in accordance with a force supposed to be applied to the patient's body by a movement of the insertion section.

22. A training method for endoscopic manipulation using an endoscopic simulator according to claim 21, further including applying an external force to the dummy, to transform the dummy, to change the three- dimensional image in accordance with the transformation of the dummy, and to actuate the insertion section of the endoscope with respect to the dummy in accordance with the change of the three-dimensional image.

23. A training method for endoscopic manipulation using an endoscopic simulator according to claim 21, further including externally pressing the dummy, to transform the dummy, to change the three-dimensional image in accordance with the transformation of the dummy, and actuating the insertion section of the endoscope with respect to the dummy in accordance with the change of the three-dimensional image.

24. A training method for endoscopic manipulation using an endoscopic simulator according to claim 23, further including changing the gravitational direction of the dummy, changing the three-dimensional image in accordance with the change of the gravitational direction of the dummy, and actuating the insertion section of the endoscope with respect to the dummy in accordance with the change of the three-dimensional image.

25. A training method for endoscopic manipulation using an endoscopic simulator according to claim 21, further including changing the gravitational direction of the dummy, changing the three-dimensional image in accordance with the change of the gravitational direction of the dummy, and actuating the insertion section of the endoscope with respect to the dummy in accordance with the change of the three-dimensional image.
